(19) United States
(12) Patent Application Publication
(10) Pub. No.: US 2025/0149603 A1
(43) Pub. Date: May 8, 2025

(54) METHOD OF CONTROLLING OPERATION OF FUEL CELL TRIPLE COGENERATION SYSTEM

(71) Applicant: KOREA INSTITUTE OF ENERGY RESEARCH, Daejeon (KR)

(72) Inventors: Min Jin KIM, Daejeon (KR); Seong Hyeon HAM, Incheon (KR); Young Jun SOHN, Daejeon (KR); Seung Gon KIM, Daejeon (KR); Hwan Yeong OH, Daejeon (KR); Yoon Young CHOI, Sejong (KR); Seok Hee PARK, Daejeon (KR); Sung Dae YIM, Daejeon (KR); Seung Hee WOO, Daejeon (KR); Yun Sik KANG, Seongnam-si (KR); Gu Gon PARK, Daejeon (KR); Eun Jik LEE, Daejeon (KR); So Jeong LEE, Daejeon (KR); Byung Chan BAE, Daejeon (KR); Dong Won SHIN, Sejong (KR); Hye Jin LEE, Daejeon (KR); Won Yong LEE, Daejeon (KR); Tae Hyun YANG, Daejeon (KR)

(73) Assignee: KOREA INSTITUTE OF ENERGY RESEARCH, Daejeon (KR)

(21) Appl. No.: 18/270,376

(22) PCT Filed: Mar. 2, 2022
(86) PCT No.: PCT/KR2022/002949

§ 371 Date: Jun. 29, 2023

(30) Foreign Application Priority Data
Feb. 28, 2022 (KR) 10-2022-0026016

(51) Int. Cl. H01M 8/04298; H01M 8/04007; H01M 8/0432; H01M 8/04537; H01M 8/04858

(52) U.S. Cl. CPC H01M 8/04305; H01M 8/04059; H01M 8/0432; H01M 8/04582; H01M 8/04604; H01M 8/0494; H01M 2250/10

(57) ABSTRACT

Disclosed is a method of controlling the operation of a fuel cell triple cogeneration system configured to supply power and cooling heat to a data center, the method including detecting change in a power load or a cooling heat load of the data center and adjusting electrical energy and cooling capacity of the fuel cell triple cogeneration system.

### CROSS-REFERENCE TO RELATED APPLICATION

This application is the National Phase of PCT/KR2022/002949 filed on Mar. 2, 2022, which claims priority under 35 U.S.C. § 119(a) to Patent Application No. 10-2022-0026016 filed in the Republic of Korea on Feb. 28, 2022, all of which are hereby expressly incorporated by reference into the present application.

### TECHNICAL FIELD

Various embodiments of the present invention relate to a method of controlling the operation of a fuel cell triple cogeneration system. More specifically, various embodiments of the present invention relate to a method of controlling the operation of a triple cogeneration system based on a high-temperature polymer electrolyte membrane fuel cell for data centers.

The present invention was derived from research conducted as part of a project to develop a polymer fuel cell system for data centers supported by the Ministry of Science and ICT (Project number: GP2020-0009, Project name: Development of a polymer fuel cell system for data centers).

### BACKGROUND ART

With the development of the information and communication technologies (ICT) industry, energy consumption in data centers continues to increase. This calls for technological advancements that go beyond reducing energy costs in data centers to embrace a low-carbon paradigm. A high-temperature polymer electrolyte membrane fuel cell (HT-PEFC) uses a polymer membrane with phosphoric acid, which results in slightly lower power generation performance than a conventional low-temperature polymer electrolyte membrane fuel cell (LT-PEFC), but the operating temperature is 120° C. or higher, and generated exhaust heat can be effectively utilized for generating cooling heat as a heat source for absorption chillers. Therefore, it is suitable for satisfying the energy needs of data centers that require both load power and cooling.

However, there is still no technology to optimize the operating mode of a fuel cell based on changes in a power load or a cooling heat load of a data center.

### DISCLOSURE

### Technical Problem

It is an object of the present invention to provide a method of controlling the operation of a fuel cell triple cogeneration system capable of optimizing the operation mode of a fuel cell according to changes in a power load or a cooling heat load of a data center.

### Technical Solution

A method of controlling the operation of a fuel cell triple cogeneration system configured to supply power and cooling heat to a data center may include detecting change in a power load or a cooling heat load of the data center and adjusting electrical energy and cooling capacity of the fuel cell triple cogeneration system.

### Advantageous Effects

The present invention is capable of accurately analyzing efficiency and cooling capacity of a triple cogeneration system according to various operation modes of a fuel cell and set values of a dual-efficiency absorption refrigerator. As a result, it is possible to provide a fuel cell operation scenario strategy that can satisfy the energy demand conditions of a data center. In addition, it is possible to provide a method of operating the fuel cell under optimal conditions, whereby it is possible to maximize efficiency of the entire system.

### DESCRIPTION OF DRAWINGS

FIG. 1 is a block diagram of a data center and a fuel cell triple cogeneration system.

FIG. 2 is a block diagram of a fuel cell triple cogeneration system according to the present invention.

FIGS. 3 and 4 are operation flowcharts of a method of controlling the operation of the fuel cell triple cogeneration system.

FIG. 5 is an I-V polarization curve showing comparison between the simulation predictions and experimental values of a model and initial parameter values at the time of validation of an HT-PEFC stack model of Example 1.

FIG. 6 is an I-V polarization curve showing comparison between simulation predictions of a model completed according to an embodiment of the present invention and experimental values.

FIG. 7 shows the effect of the operating temperature of a stack on performance.

FIG. 8 shows power based on the operating temperature of the stack.

FIG. 9 shows efficiency based on the operating temperature of the stack.

FIG. 10 shows power and efficiency based on the current density of the stack.

FIG. 11 shows COP based on the cooling water inlet temperature.

FIG. 12 shows cooling capacity based on the cooling water inlet temperature.

FIG. 13 shows COP based on the operating temperature of the stack and the chilled water outlet temperature.

FIG. 14 shows cooling capacity based on the operating temperature of the stack and the chilled water outlet temperature.

### BEST MODE

Various embodiments of the present disclosure will be hereinafter described with reference to the accompanying drawings. Embodiments and the terms used therein are not intended to limit the technology described herein to any specific embodiment and should be understood to include various modifications, equivalents, and/or substitutions of such embodiments.

Hereinafter, preferred embodiments of a modeling method for fuel cell flow field design according to the present invention will be described in detail with reference to the accompanying drawings.

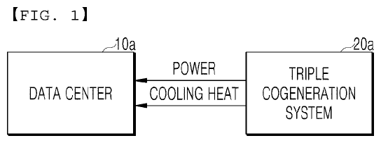

FIG. 1 is a block diagram of a data center and a fuel cell triple cogeneration system. Referring to FIG. 1, the fuel cell triple cogeneration system 20a may provide power and cooling heat to the data center 10a.

The data center 10a is a building or facility that houses servers, network hardware, and the like, and requires a cooling heat system configured to cool a high-power electrical load and to remove heat generated from IT devices in order to safely and efficiently provide information and communication technologies (ICT) services year-round. Thus, the fuel cell triple cogeneration system 20a of the present invention may provide power and cooling heat to the data center 10a.

Specifically, the fuel cell triple cogeneration system 20a of the present invention may include a high temperature polymer electrolyte membrane fuel cell (HT-PEFC) and a dual-efficiency absorption refrigerator (AR). That is, electricity generated from renewable energy may be provided to the data center 10a through the high temperature polymer electrolyte membrane fuel cell (HT-PEFC). In addition, cooling heat may be provided to the data center 10a through the dual-utility absorption refrigerator (AR) using waste heat (exhaust heat) released from the high temperature polymer electrolyte membrane fuel cell (HT-PEFC).

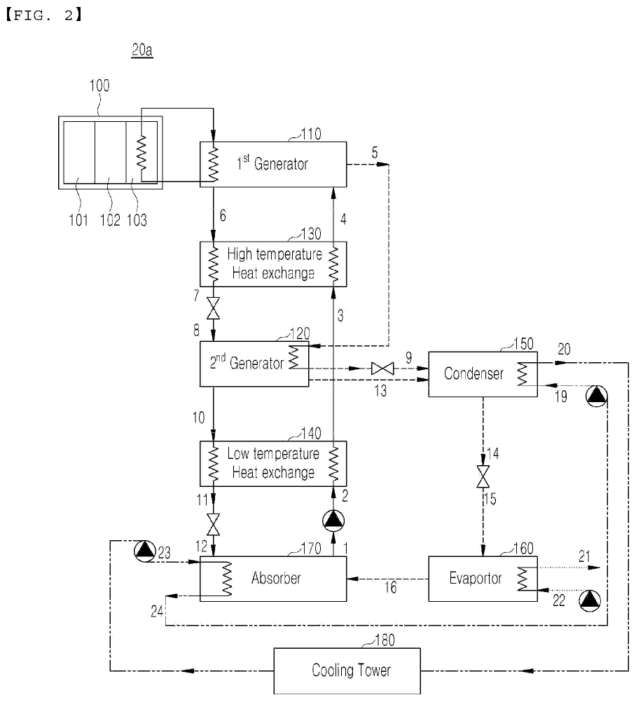

More specifically, the fuel cell triple cogeneration system 20a of the present invention will be described with reference to FIG. 2. FIG. 2 is a block diagram of the fuel cell triple cogeneration system of the present invention. Referring to FIG. 2, the fuel cell triple cogeneration system 20a may include a fuel cell stack 100, a first generator 110, a second generator 120, a high temperature heat exchanger 130, a low temperature heat exchanger 140, a condenser 150, an evaporator 160, an absorber 170, and a cooling tower 180.

The fuel cell stack 100 includes a hydrogen electrode 101, an air electrode 102, and a refrigerant steam generator 103 integrated with a cooling channel, and the fuel cell stack 100 in this embodiment is preferably applied to a triple cogeneration system where the fuel cell operating temperature is in the range of 100 to 250° C. Although not shown, an electrolyte membrane is included between the hydrogen electrode 101 and the air electrode 102, and electricity is generated through the reaction at the hydrogen electrode 101 and the air electrode 102, and the generated electricity is transmitted to the outside through an inverter.

The fuel cell stack 100 is typically configured to have a structure in which a plurality of hydrogen electrodes 101, a plurality of air electrodes 102, and a plurality of cooling plates are repeatedly stacked, which is shown in a simplified form in FIG. 2. A typical high temperature polymer electrolyte membrane fuel cell is configured to include an independent refrigerant flow channel through the cold plate. Conventional technologies combining a heat pump and a fuel cell to form a triple cogeneration system also include separate cooling fluid flow channels for the fuel cell and the heat pump. However, in the present invention, the integral refrigerant steam generator 103 integrates the separately configured flow channels into an integrated flow channel, thereby reducing the number of devices, such as the condenser and the pump, used in the fuel cell as well as the fluid flow channel, thereby reducing the size of the entire system and enabling more efficient heat utilization.

That is, the integral refrigerant steam generator 103 in the fuel cell stack 100 of the present invention may simultaneously perform the function of stack cooling as a fuel cell stack and the function of a steam generator that evaporates a refrigerant in an aqueous refrigerant solution, which is a cooling fluid solution, as an absorption heat pump.

The absorption heat pump in the present invention is a concept that includes an absorption refrigerator, and therefore the absorption heat pump of the present invention may be interpreted as an absorption refrigerator.

For a cooling fluid configured to cool the fuel cell as a fluid in the heat pump, a refrigerant contained in the cooling fluid is evaporated by the heat from the fuel cell stack 100. Depending on a load of the fuel cell, most of the refrigerant is evaporated when the temperature is high, and most of the cooling fluid passes in a liquid phase and is introduced into a gas-liquid separator when the temperature is low.

The first generator 110 may include an integral refrigerant steam generator 103 and a small gas-liquid separator configured to separate a circulating cooling fluid supplied therefrom into gas and liquid phases. The first generator 110 generates refrigerant steam from the circulating cooling fluid solution. The amount of the refrigerant in the gas phase circulating fluid may be further increased by providing additional heat as needed.

The gas phase refrigerant discharged from the first generator 110 may be supplied directly to a liquid phase unit of the second generator 120 via a pipe 5. Alternatively, the gas phase refrigerant discharged from the first generator 110 may be supplied to the condenser 150 via pipes 5 and 13 including pipes configured to transfer only heat to the liquid phase unit.

The refrigerant supplied to the condenser 150 via pipes 5 and 9 may lose heat while passing through second generator 120, whereby some of the refrigerant may be liquid. In addition, the refrigerant supplied to the condenser 150 may be in contact with a heat exchanger through which hot cooling water flows, such as by spraying, in the condenser 150.

The liquid cooling fluid separated from the first generator 110 is introduced into the second generator 120 through a pipe 6. The high temperature heat exchanger 130 may be disposed in a part of pipes 6, 7, and 8. Heat collected through the high temperature heat exchanger 130 may be used to raise the temperature of the cooling fluid supplied to the integral refrigerant steam generator 103 included in the fuel cell stack 100, or may be used for building heating.

Meanwhile, in the second generator 120, a part of the aqueous solution, which is a liquid circulating cooling fluid, may be evaporated with the gas phase refrigerant supplied from the first generator 110 via the pipe 5, and the evaporated refrigerant is introduced into the condenser 150 via the pipe 13.

The liquid cooling fluid from the second generator 120 is supplied to the absorber 170 via pipes 10, 11, and 12. The low temperature heat exchanger 140 may be disposed in a part of the piping 10, 11, and 12. In the same manner as the high temperature heat exchanger 130, the low temperature heat exchanger 140 may raise the temperature of the aqueous solution supplied to the integral refrigerant steam generator 103 included in the fuel cell stack 100.

Meanwhile, the absorber 170 may receive low-temperature cooling water from the cooling tower 180 through a pipe 23, may raise the temperature of the low-temperature cooling water through a heat exchanger in the absorber 170, and may discharge the high-temperature cooling water through a pipe 24. The discharged high-temperature cooling water is supplied to the condenser 150 through pipes 24 and 19. The high-temperature cooling water supplied to the condenser 150 is further raised in temperature through a heat exchanger in the condenser 150 and is supplied back to the cooling tower 180 through a pipe 20.

The condenser 150 includes a high-temperature cooling water pipe separate from the circulating fluid pipe therein, and the gas phase circulating fluid comes into contact with the high-temperature cooling water pipe and is converted to a liquid phase by condensation. In addition, in order to supply hot water for heating from the condenser 150, the temperature of the high-temperature cooling water is raised by heat collected by the condenser 150, and the high-temperature cooling water may be used for purposes such as heating a building and supplying hot water.

The liquid refrigerant discharged from the condenser 150 is introduced into the evaporator 160 through pipes 14 and 15. In the evaporator 160, the refrigerant supplied through the pipes 14 and 15 is brought into contact with the surface of a hot water pipe through the internal heat exchanger using a method such as spraying, and the refrigerant in contact with the hot water pipe evaporates and is introduced into the absorber 170 through the pipe 16. Hot water heated by hot air in the building is supplied to the evaporator 160 through a pipe 22, and the temperature of the hot water is reduced by the refrigerant in the evaporator 160. The reduced-temperature chilled water may be introduced again into the building through a pipe 21 and may be utilized for cooling the building. The evaporator 160 and absorber 170 may be configured as an integral chamber with no separate pipe, and the gas phase refrigerant discharged from the evaporator 160 is directly introduced into the absorber 170 through the pipe 16 or the integral chamber. If no cooling is required in the building, the refrigerant is directly supplied from the evaporator 160 to the absorber 170 without any reaction. In the absorber 170, the heat generated from the aqueous cooling fluid absorbing the steam of the refrigerant is discharged through the internal heat exchanger using the high-temperature cooling water pipe 24, whereby the temperature of the circulating fluid solution is lowered, and therefore the fuel cell stack 100 may be cooled. Additionally, the heat collected by the absorber 170 may be used for heating purposes.

The cooling fluid discharged from the absorber 170 is supplied to the first generator 110 through the pipes 1, 2, 3, and 4 via the pump, and the above sequence of processes is repeated, whereby cooling of the fuel cell and heating and cooling of the building are possible.

Cooling water from the cooling tower 180 may flow through the absorber 170 and then through the condenser 150 to cool the absorber 170 and the condenser 150. A part of the circulation structure may include a structure configured to supply hot water to a building or the like.

The pump may adjust the flow rate of the cooling fluid based on the temperature of the fuel cell stack 100, and to this end, may further include a flow controller (not shown) for controlling the pump speed.

Meanwhile, the outlet temperature of the chilled water produced by the evaporator 160 may be measured using a temperature sensor in the pipe 21. As a result, it is possible to check the cooling capacity and COP behavior based on the outlet temperature of the chilled water. Alternatively, the cooling water inlet temperature of the chilled cooling water entering the absorber 170 via the cooling tower 180 may be measured using a temperature sensor in the pipe 23, whereby it is possible to calculate the cooling capacity and COP based on change in the cooling water inlet temperature.

The cycle of the cooling fluid including the refrigerant in the present invention may be specifically divided into two cycles: the first is the cycle of the solution (cooling fluid) including the refrigerant (generator->absorber->generator), and the second is the cycle of the refrigerant in the cooling fluid (generator->condenser->evaporator->absorber->generator).

Specifically, the cycle of the cooling fluid is shown as the cycle through pipes 6, 7, 8, 10, 11, 12, 1, 2, 3, and 4 and is indicated by a solid line in FIG. 2. The cycle of the refrigerant in the cooling fluid is shown as the cycle through the pipes 5, 9, 13, 14, 15, and 16 and is indicated by a long dashed line in FIG. 2. Meanwhile, the cooling water is represented by a double dashed line as the cycle through the pipes 23, 24, 19, and 20.

It is preferable to use a solution that is susceptible to evaporation while passing through the integral refrigerant steam generator 103 as the cooling fluid that circulates in the cooling fluid cycle including the refrigerant. For example, the solution may be an aqueous lithium bromide solution (LiBr—H₂O) or an aqueous ammonia solution (NH₃—H₂O).

Liquid that has a low evaporation point in an aqueous solution and is easily evaporated may be used as the refrigerant. In the case of the aqueous lithium bromide solution (LiBr—H₂O), the refrigerant may be water, and in the case of the aqueous ammonia solution (NH₃—H₂O), the refrigerant may be ammonia. In addition, any of various aqueous solutions, such as LiCl—H₂O, LiI—H₂O, CaCl₂—H₂O, KNO—H₂O, and NH₃—LiNO₃, may be used as the cooling fluid, and at least two thereof may be mixed.

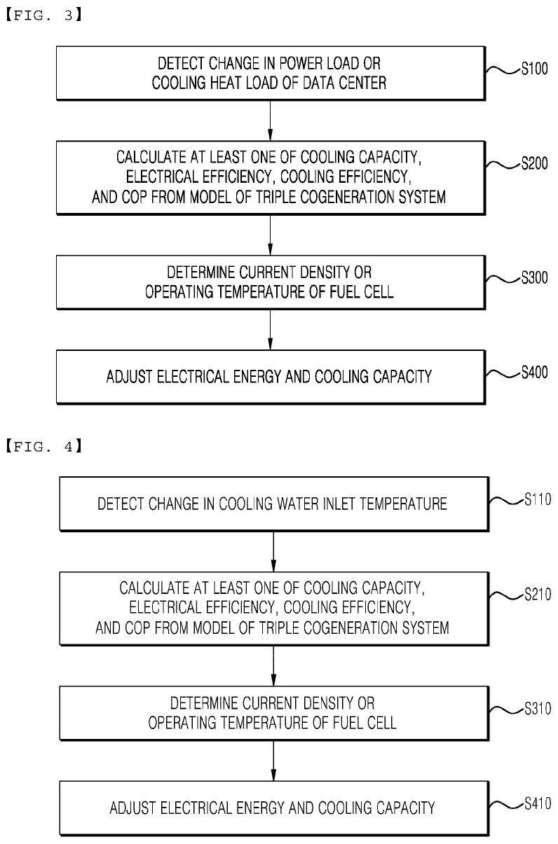

Hereinafter, a method of controlling the operation of the fuel cell triple cogeneration system 20a described above will be described. FIG. 3 is an operation flowchart of the method of controlling the operation of the fuel cell triple cogeneration system 20a.

The method of controlling the operation of the fuel cell triple cogeneration system 20 according to various embodiments of the present invention may include a step of detecting change in a power load or a cooling heat load of a data center and a step of adjusting electrical energy and cooling capacity of the fuel cell triple cogeneration system.

First, in the step of detecting change in the power load or the cooling heat load of the data center (S100), change in the power load or change in the cooling heat load required by the data center may be detected. That is, increase or decrease in the power load required by the data center may be detected, or increase or decrease in the cooling heat load required by the data center may be detected. Meanwhile, the change in the power load may be measured by an electrical energy measurement unit of the data center. The change in the cooling heat load may be measured by a cooling heat measurement unit of the data center. The electrical energy measurement unit and the cooling heat measurement unit may be provided in the data center or may be configured separately.

Next, the step of calculating at least one of cooling capacity, electrical efficiency, cooling efficiency, and a coefficient of performance (COP) from a modeled model of the fuel cell triple cogeneration system (S200) may be performed.

Specifically, the model of the fuel cell triple cogeneration system may be derived by 1) modeling the high temperature polymer electrolyte membrane fuel cell (HT-PEFC) and 2) modeling the dual efficiency absorption refrigerator (AR).

HT-PEFC modeling may be divided into stack modeling and system modeling. First, components in a stack for stack modeling are a polybenzimidazole (PBI) membrane, a hydrogen electrode catalyst layer, an oxygen electrode catalyst layer, a hydrogen electrode gas diffusion layer, and an oxygen electrode gas diffusion layer, and the influence of a gas channel is not included in this model. In order to perform simulation related to electrochemical reaction and material balance in the cell, gPROMS ProcessBuilder (version 1.5.3) from PSE, which is a commercial program, was used and the following assumptions were made to simplify the simulation.
All reactions are steady-state and occur under ideal gas conditions.
A reactant does not permeate an electrolyte.
Contact resistance in each component is ignored.
Diffusion layers (GDLs and catalyst layers) are isotropic and homogeneous.
In addition, PBI-based membrane characteristics and operating characteristics of HT-PEFC are reflected, whereby a reaction product, i.e. water, always exists in a gaseous state, and an electroosmotic traction phenomenon may be ignored.

The HT-PEFC model may be derived from the following governing equation.

Fuel cell voltage (real cell voltage) may be calculated as a function of current, taking into account the reversible voltage and losses, such as activation over-potential, ohmic over-potential, and diffusion over-potential.

$${V}_{cell} = {V}_{rev} - {η}_{act} - {η}_{ohm} - {η}_{c o n c} \qquad ( 1 )$$

Nernst reversal voltage, taking into account an entropy loss at the operating temperature of the fuel cell and the concentration of reactant gas in an open circuit, may be expressed as follows. V^{ref} may be found using Gibbs free energy under standard conditions.

$${V}_{rev} = {V}^{ref} + \frac{Δ s}{n F} ( T - {T}_{ref} ) + \frac{R T}{n F} ln \frac{{P}_{H 2} {P}_{O 2}^{0.5}}{{P}_{H 2 O}} \qquad ( 2 )$$

In order to calculate the activation over-potential, the following Butler-Volmer's equation was used.

$$i = {i}_{0} \{ exp ( \frac{- {α}_{Rd} F {η}_{act}}{RT} ) - exp ( \frac{{a}_{Ox} F {η}_{act}}{R T} ) \} \qquad ( 3 )$$

$${i}_{0} = {i}_{0}^{ref} {a}_{c} {{L}_{c} ( \frac{{P}_{r}}{{P}_{r}^{r e f}} )}^{γ} exp [ - \frac{{E}_{c}}{R T} ( 1 - \frac{T}{{T}_{ref}} ) ] \qquad ( 4 )$$

Here, iₒ is reaction exchange current density, iₒ^{ref} is reference exchange current density, α_{Rd} is a reduction charge transfer coefficient in the cathode, αₒₓ is an oxidation charge transfer coefficient in the cathode, E_{c} is activation energy of the catalyst layer, T_{ref} is a reference temperature, and α_{c}L_{c} is the catalyst surface area (cm²) per geometric area (cm²) of the electrode, also known as electrode roughness.

Since the resistance loss at the electrode is almost negligible, the ohmic over-potential may be represented by the loss of the electrolyte alone. The ionic conduction loss of the electrolyte may affect the thickness and ionic conductivity thereof.

$${η}_{o h m} = {i}_{cell} \frac{{t}_{m}}{{κ}_{m}} \qquad ( 5 )$$

The ionic conductivity of a phosphate-loaded PBI electrolyte membrane is a function of phosphate loading rate, humidity amount, and temperature, and may be expressed by the following Arrhenius equation.

$${k}_{m} ( ionic conductivity ) = \frac{αβ}{T} exp ( - \frac{{E}_{ion}}{RT} ) \qquad ( 6 )$$

Eᵢₒₙ used in Equation (6) is activation energy, α is the effect of phosphate loading rate, and β is a constant used to reflect the effect of temperature and relative humidity amount. Thereamong, β is a value originally proposed by K. Jiao, where different governing equations are applied according to the three operating temperature zones, but in order to reduce the complexity of application in the program, modification was made as represented by the following equation (9).

$${E}_{íon} = - 6 19.6 DL + 21750 J / mol \qquad ( 7 )$$

$$α = 168 {DL}^{3} - 6324 {DL}^{2} + 6 \; 5750 DL + 8460 \qquad ( 8 )$$

$$β = 1 + R H ( - 3802.64 + 28.1 \; 2133 T - 0.0 \; 6933 {T}^{2} + 570 {E}^{- 5} {T}^{3} ) \qquad ( 9 )$$

$${RH}^{eff} = \{ \begin{matrix}RH & in catalyst layer \\ {RH}_{avg} & in membrane\end{matrix} \qquad ( 10 )$$

$${P}_{s a t} = 0.6 \; 8737 {T}^{3} ( K ) - 73 2.39 {T}^{2} ( K ) + 26 \; 3390 T ( K ) - 31919000 Pa \qquad ( 11 )$$

The relational expression of voltage loss due to concentration polarization may be obtained as follows.

$${η}_{c o n c} = \frac{R T}{n F} ln ( \frac{{i}_{L}}{{i}_{L} - {i}_{c e l l}} ) \qquad ( 12 )$$

The stack voltage and power are calculated as the product of the number of cells and the cell voltage, and the total power of the stack is calculated as the product of the stack voltage and the cell current.

$${V}_{Stack} = {n}_{cell} {V}_{cell} \qquad ( 13 )$$

$${P}_{stack} = {n}_{cell} {V}_{cell} \cdot i \cdot {A}_{M E A} \qquad ( 14 )$$

The unit cell efficiency is calculated as the voltage output relative to the theoretical potential and the stack efficiency may be calculated using the fuel utilization rate (μ_{fuel}), which represents the consumption of fuel used in the fuel cell electrochemical reaction.

$${η}_{cell} = \frac{{V}_{cell}}{{V}_{the}^{ref}} \qquad ( 15 )$$

$${η}_{Fc\_stack} = {μ}_{fuel} \frac{{V}_{cell}}{{V}_{the}^{ref}} \qquad ( 16 )$$

Heat generated from the HT-PEFC stack may be calculated using the following equation.

$$\begin{matrix}{\dot{Q}}_{stack} = ( {V}_{the}^{ref} - {V}_{cell} ) \times i \times {A}_{MEA} \times {n}_{cell} \\ = {P}_{stack} ( \frac{{V}_{the}^{ref}}{{V}_{cell}} - 1 ) \\ = {P}_{stack} ( \frac{1 - {η}_{cell}}{{η}_{cell}} )\end{matrix} \qquad ( 17 )$$

For validation of the model derived from the governing equation above, the “Parameter estimation method” may be used to estimate the value based on the experimental value.

Next, the system model of the HT-PEFC model may specifically provide information on the heat source delivered to the AR by predicting the amount of stack power generation, electrical efficiency, and the amount of heat generated according to operating conditions, such as operating temperature and applied current density. The system model includes three modules: a hydrogen fuel supply system, an air supply system, and a heat collection system.

In the hydrogen fuel supply system, gas discharged from the fuel cell stack by a hydrogen circulator is circulated to the hydrogen supply side to improve hydrogen fuel economy. A purge valve installed in a hydrogen discharge channel is opened and closed at regular intervals according to the concentration of water and nitrogen that may accumulate in the fuel electrode in order to discharge exhaust gas to the outside and to prevent hydrogen depressurization. An H₂ recirculation pump is modeled by the pump module. The rate of rotation of the pump regulates the supplied hydrogen flow rate (mass flow rate of H₂_source) to the target value of the mass flow rate of H₂_Mix such that the amount of hydrogen supplied to the fuel cell stack is uniform. Inputs to the pump model include the outlet pressure and efficiency, and power consumption is calculated.

The air supply system is a structure that uses a heat exchanger to exchange heat between the air entering the stack inlet and the air exiting the stack outlet. The heat exchanger performance (area, thermal conductivity) was designed according to the heat balance equation in Equations (18) and (19) using a log mean temperature difference (LMTD) method, which is widely used for heat transfer calculation of the heat exchanger,

$${Q}_{c} = {UA}_{C} LMTD \qquad ( 18 )$$

$$LMTD = \frac{{( {T}_{h o t} - {T}_{cool} )}_{i n} - {( {T}_{h o t} - {T}_{c o o l} )}_{OUT}}{ln \frac{{( {T}_{hot} - {T}_{C = cool} )}_{i n}}{{( {T}_{hot} - {T}_{cool} )}_{OUT}}} \qquad ( 19 )$$

The heat collection system is a module configuration for circulating a triethylene glycol (TEG) refrigerant that plays a heating and cooling role in the HT-PEFC. The temperature of the stack outlet is set to a target value, and the flow rate of the TEG_Source is adjusted from a given initial guess to achieve the target. Inputs to the pump model include the outlet pressure and efficiency. Power consumption is calculated based on the TEG flow rate.

Next, a new model for calculating the efficiency and performance of a dual-efficiency absorption system may be used as 2) the dual-efficiency absorption refrigerator (AR) Model.

First, the amount of exhaust heat (Q_{H}) of the fuel cell is defined as the sum of heat input (Q_{G1}) of the first generator and heat input (Q_{G2}) of the second generator.

Q_{G2} reflects the effect of performance improvement in which the water vapor of the refrigerant obtained by heating a dilute solution in the first generator becomes the heat source in the second generator and is used to heat the absorption solution again, and may be applied by calculating the heat input ratio (α) of the second generator to the first generator.

$${Q}_{H} = {Q}_{G 1} = {m}_{17} \cdot {h}_{17} - {m}_{18} \cdot {h}_{18} \qquad ( 20 )$$

$${Q}_{G 2} = {m}_{5} \cdot {h}_{5} - {m}_{13} \cdot {h}_{13} \qquad ( 21 )$$

$${Q}_{G} = {Q}_{G 1} + a {Q}_{G 1} \qquad ( 22 )$$

In the case of a dual-efficiency absorption refrigerator, the drive heat source (Q_{G1}) is supplied to the first generator, and the generated refrigerant steam (Q_{G2}) is supplied to the second generator again so as to be heated and to generate refrigerant steam, thereby increasing efficiency. Therefore, the final COP is the cooling capacity (Q_{E}) produced relative to the amount of heat input and may be calculated as follows.

$$COP 1 = \frac{{Q}_{E 1}}{{Q}_{G 1}} \qquad ( 23 )$$

$$COP 2 = \frac{{Q}_{E 2}}{{Q}_{G 1}} \qquad ( 24 )$$

Electrical efficiency (ηₑₗ) of the whole system is calculated as the ratio of fuel cell system output (P_{FC}) to input energy of fuel cell (Qᵢₙ). Cooling efficiency (η_{cooling}) is calculated as the ratio of cooling capacity (Q_{E}) to input energy of fuel cell (Qᵢₙ).

Here, P_{accessory} is the power of accessories consumed by the fuel cell system and consists of the power consumption calculated in the developed HT-PEFC system model (H₂ recirculation pump, stack air blower, and oil pump) and the power consumption of the pump in the cooling tower used in the absorption cooling system. During the absorption process, the absorption heat is generated and the temperature of the solution increases, whereby the absorption capacity of the steam is reduced. Therefore, the absorber 170 needs to be continuously cooled by cooling water or air for a continuous absorption process. FIG. 2 shows that cooling water from the cooling tower 180 passes through the absorber 170 and through the condenser 150 to cool these two parts.

That is, definitions of the terms used in the modeling method described above are shown in Table 1 below.

TABLE 1

| | |
|---|---|
| Input energy of fuel cell | Qᵢₙ = m_{H2} · LHV_{H2} |
| Stack power | P_{stack} |
| Stack heat | \dot{Q}_{stack} = Q_{G1} |
| Heat source of generator | Q_{G} = Q_{G1} + αQ_{G1} |
| Cooling capacity | Q_{E} |
| BOP | p_{accessory} = p_{Oil pump} + p_{Air}_{_{blower}} + |
| | + p_{recirculation}_pump + p_{Cooling}_tower |
| Fuel cell system output | P_{Fc} = P_{stack} · ηᵢₙᵥₑₜₑᵣ - p_{accessory} |
| Electrical efficiency | ${η}_{el} = \frac{{P}_{FC}}{{Q}_{i n}}$ |
| Cooling efficiency | ${η}_{cooling} = \frac{{Q}_{E}}{{Q}_{i n}}$ |
| COP | $COP 2 = \frac{{Q}_{E}}{{Q}_{G 1}}$ |

Referring back to FIG. 3, a step of determining the current density or operating temperature of the fuel cell (S300) may next be performed. As a result, the electrical energy and cooling capacity of the fuel cell triple cogeneration system may be adjusted (S400) to satisfy the demand conditions of the data center.

The cooling capacity, electrical efficiency, cooling efficiency, and COP according to the stack operation mode and AR set values (cooling water inlet temperature or chilled water outlet temperature) may be calculated from the model described above.

For example, the behavior of cooling capacity, electrical efficiency, cooling efficiency, and COP due to increase in the stack operating temperature may be checked.

That is, as the stack operating temperature increases, the amount of heat transferred to the first generator decreases, but the temperature of the first generator increases, whereby the amount of steam evaporated from the working fluid increases and the cooling capacity increases.

In addition, as the stack operating temperature increases, a larger amount of electricity is generated by the stack, whereby the fuel cell stack efficiency and system efficiency increases, and the cooling capacity increases, whereby the COP and cooling efficiency increase.

In the present invention, it is possible to derive an optimized stack operating temperature based on the power load or the cooling heat load required by the data center through the modeled model.

Meanwhile, it is possible to check the behavior of cooling capacity, electrical efficiency, and cooling efficiency due to an increase in the stack current density from the above model.

That is, as the stack current density increases, the irreversible over-potential of the fuel cell stack increases, whereby the electrical efficiency of the fuel cell system decreases, but a larger amount of heat than the electrical energy is generated in the stack, whereby the cooling efficiency increases as the cooling capacity increases.

In the present invention, therefore, it is possible to adjust the stack current density according to the power load or the cooling heat load required by the data center through the modeled model.

Meanwhile, it is possible to check the behavior of the cooling capacity and the COP according to the outlet temperature of the chilled water produced by the fuel cell triple cogeneration system from the above-described model. Specifically, referring to FIG. 2, the outlet temperature of the chilled water, which is the outlet temperature of the chilled water produced by the evaporator 160, may be measured using a temperature sensor in the pipe 21.

The higher the temperature of the evaporator 160, the more refrigerant steam is produced in the first generator 110, and therefore increasing the outlet temperature of the chilled water increases the COP and cooling capacity.

In most cases, typical refrigerator control is performed to uniformly control the outlet temperature of the chilled water, and as the cooling load of the system decreases in the control method, the chilled water outlet temperature decreases accordingly.

Therefore, the cooling capacity according to the chilled water outlet temperature may be calculated based on the temperature and humidity conditions of the data center, and the fuel cell stack operating temperature may be selected according to the power load or the cooling heat load required by the data center.

Meanwhile, a method of controlling the operation of a fuel cell triple cogeneration system 20a according to another embodiment of the present invention will be described. FIG. 4 is an operation flowchart of the method of controlling the operation of the fuel cell triple cogeneration system 20a.

Referring to FIG. 4, the method of controlling the operation of the fuel cell triple cogeneration system 20a may include a step of detecting change in cooling water inlet temperature (S110), a step of calculating at least one of the cooling capacity, the electrical efficiency, the cooling efficiency, and the COP from a model of the fuel cell triple cogeneration system (S210), a step of determining the current density or the operating temperature of the fuel cell (S310), and a step of adjusting the electrical energy and the cooling capacity of the fuel cell triple cogeneration system (S410). S210, S310, and S410 may be performed in the same manner as S200, S300, and S400 of FIG. 3 previously described.

In the step of detecting the change in the cooling water inlet temperature (S110), change in the cooling water inlet temperature of the cooling tower 180 may be detected. Specifically, the cooling water inlet temperature may be measured using a temperature sensor in the pipe 23, which is the inlet for the cooling water cooled as the result of passing through the cooling tower 180 to enter the absorber 170, in FIG. 2

The cooling water inlet temperature may vary depending on the season and local climate, and as the cooling water inlet temperature rises, the temperatures of the absorber and the condenser rise, the cooling efficiency is lowered, and therefore the cooling capacity and the COP are reduced.

Thus, the cooling capacity and the COP depending on the cooling water inlet temperature may be calculated through the modeled model, and the operating temperature of the fuel cell may be determined.

For example, when the cooling water inlet temperature increases with the outside air temperature in summer, the amount of cooling heat produced by the triple cogeneration system decreases, and therefore the fuel cell stack temperature may be increased to compensate for the lack of the amount of production of cooling heat.

In winter, the temperature in the data center is relatively lowered, which reduces the demand for cooling heat, and the cooling water inlet temperature also decreases. Therefore, the fuel cell stack temperature may be lowered in order to match the demand of the amount of cooling heat produced by the system. At this time, the fuel cell stack has an advantage in that the degradation in performance of the stack is slowed down at lower temperatures, whereby stack lifespan may be increased.

Hereinafter, the present invention will be described in detail with reference to specific examples.

However, the following examples are intended to illustrate the present invention and are not intended to limit the present invention.

### Example 1: Validation of HT-PEFC Stack Model

Initial parameter values reflecting the operating and structural conditions of a model modeled from HT-PEFC stack modeling were applied as actual physical variable values used during development of a 5 kW HT-PEFC stack as shown in Table 2 below, and other variables without actual values were set as initial parameter values by referring to other references. Accuracy of the HT-PEFC model was verified through comparison with experimental data from the fuel cell laboratory of the Korea Institute of Energy Research (KIER).

TABLE 2
Geometric/operating conditions and input parameters
for simulation of the HT-PEFC stack

| Parameters | Value | |
|---|---|---|
| Activated area (A_{MEA}) | 300 | cm² |
| Operation Temperature (T_{cell}) | 150-180° | C. |
| Anode/Cathode stoichiometry (λₐ, λ_{c}) | 1.3/2.0 | |
| Number of cells in a stack, (n_{cell}) | 160 | |
| Thickness of anode/cathode CLs, | 0.05, 0.3, 0.05, 0.3 | mm |
| GDLs, (δ_{aCL}, δ_{aGDL}, δ_{cCL}, δ_{cGDL}) | | |
| Thickness of membrane, (δ_{MEM}) | 0.05 | mm |
| Reference Pressure (P_{H}_{₂}_{, ref}/P_{O}_{₂}_{, ref}) | 1 | bar |
| Electric conductivity of anode/cathode | 1250, 300, 1250, 300 | S/m |
| in GDL, CL (σ_{GDL}, σ_{GDL}, σ_{GDL}, σ_{CL}) | | |
| Phosphoric acid doping level (DL) | 30 | |
| Reduction/Oxidation charge transfer | 0.4, 0.99 | |
| coefficient ORR (α_{Rd}/α_{Ox}) | | |
| Reference exchange current | 3.7757 × 10⁻⁶ | A/cm² |
| density (i₀^{ref}) | | |
| Activation energy (E_{c}) | 69771 | J/mol |

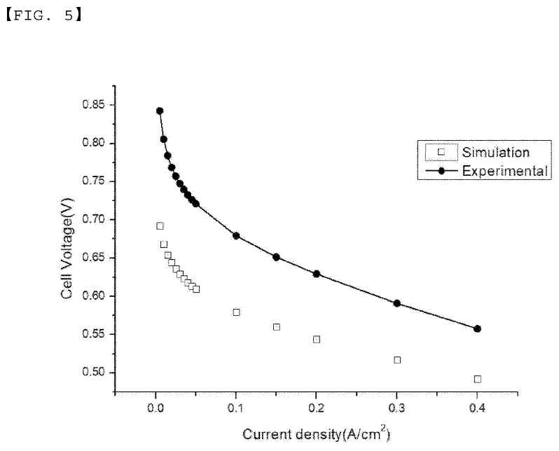

FIG. 5 is an I-V polarization curve showing comparison between predictions of model simulation with the initial parameter values and experimental values, and it can be seen that the simulation prediction does not reflect experimental data well. In order to complete a model that accurately reflects characteristics of the developed high-temperature MEA, it is impossible to accurately derive or measure variable values to be used in the model. In this example, therefore, a ‘parameter estimation method’ was used to estimate the values based on the experimental values. Table 3 below shows the newly found values of the variables affecting the kinetic response, which were estimated by the “parameter estimation method”. The model was completed by substituting the obtained values, and then simulation was performed again.

TABLE 3

| Electrochemical parameters | Before | After |
|---|---|---|
| Oxidation charge transfer | 0.5 | 0.99 |
| coefficient, (αₒₓ, OOR) | | |
| Reduction charge transfer | 0.5 | 0.40 |
| coefficient, (α_{Rd}, OOR) | | |
| Electrode roughness | — | 316 |
| (L_{c} (mgPtcm⁻²) · a_{c} (cm²mg⁻¹) | | |

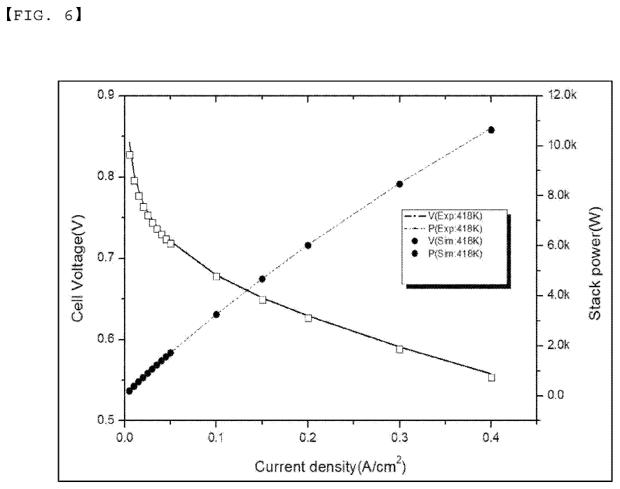

FIG. 6 shows an I-V polarization curve showing comparison between simulation predictions of the completed model and experimental values. Overall, it can be seen that the I-V polarization curves of the simulation predictions and the experimental values are consistent, and the model performance evaluation by RMSE (Root Mean Square Error) shows that the model has a very high prediction accuracy of about 99.5% or more.

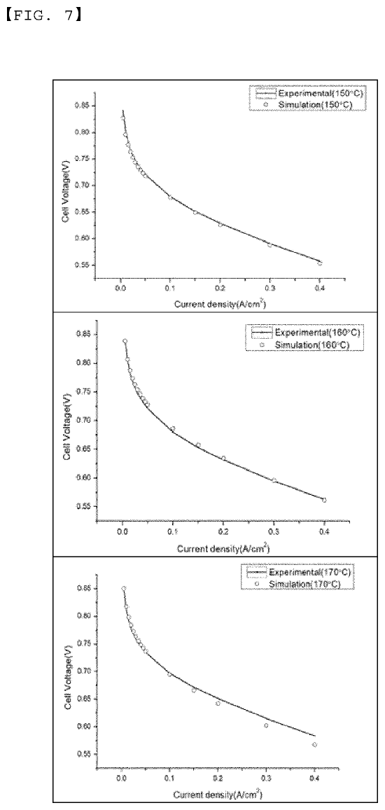

FIG. 7 shows the effect of the operating temperature of the stack on the performance. It can be seen that the performance improves as the temperature increases, and the developed model is compared with the experimental values to see if the mode reflects the effect of operating temperature well. In Table 4, the RMSE performance of the model is more than 99% at 150° C., 160° C., and 170° C., respectively, which verifies that the model reflects the fuel cell operating temperature characteristics well.

TABLE 4

| Experiment | | | After (ŷᵢ - yᵢ)² | | |
|---|---|---|---|---|---|
| 150° C. | 160° C. | 170° C. | 150° C. | 160° C. | 170° C. |

| | | | |
|---|---|---|---|
| $1 - R M S E ( Root Mean Square Error ) = 1 - \sqrt{\frac{{{Σ}_{i = 1}^{n} ( {\hat{y}}_{i} - {y}_{i} )}^{2}}{n}}$ | 0.994 | 0.994 | 0.993 |

### Example 2: Comparison in Output Change Based on Stack Operating Temperature

As the stack operating temperature increases, the electrode becomes more reactive, whereby a larger amount of electricity is generated by the stack and the amount of heat generated incidentally is reduced. Since the amount of heat is reduced, the amount of heat transferred to the generator is also reduced.

Although the amount of heat transferred decreases as the stack operating temperature increases, the amount of steam evaporated from the working fluid increases as the temperature of the generator increases, whereby the cooling capacity of the AR increases.

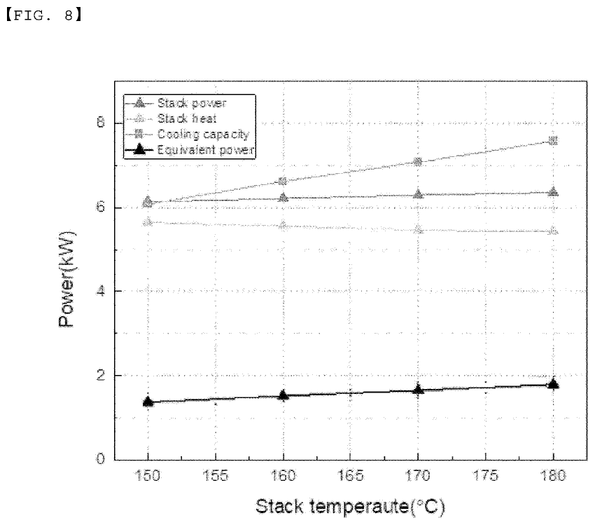

Referring to FIG. 8, this model may be explained by an increase in equivalent power as the operating temperature of the stack increases.

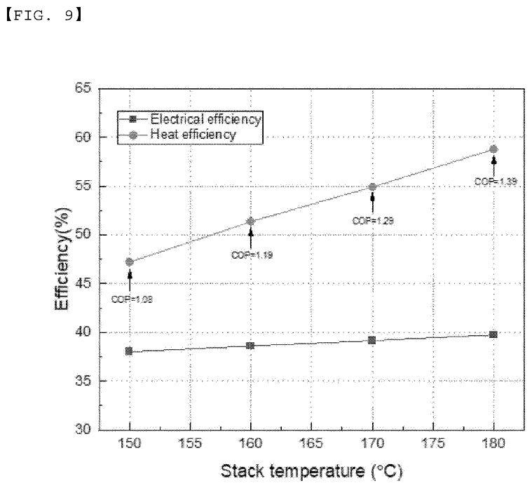

Meanwhile, referring to FIG. 9, as the stack operating temperature increases, the amount of electricity generated by the stack increases, whereby the fuel cell stack efficiency and system efficiency are improved, and the cooling capacity of the AR increases, whereby the COP and cooling efficiency increase.

A representative stack used in this example has an overall combined cooling and electrical efficiency of about 90% at an operating temperature of 160° C.

### Example 3: Comparison in Performance Based on Stack Load

As the stack load increases, because the irreversible over-potential of the fuel cell stack increases, whereby the electrical efficiency of the fuel cell system decreases, but more heat is generated in the stack than electrical energy, and therefore the cooling efficiency of the AR increases as the cooling capacity increases.

When the electricity and the cooling heat load of the data center change, the current density of the fuel cell may be adjusted to provide electricity and the amount of generation of cooling heat so as to match the load.

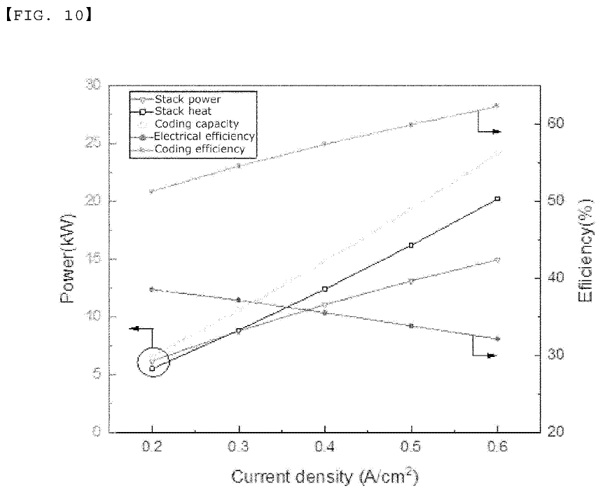

Referring to FIG. 10, as the ratio of stack heat to heat input increases more than the ratio of stack power to heat input with increasing current density, the cooling efficiency (Q_{E}/Qᵢₙ) and heat input increase, but the heat source temperature remains the same, and therefore the COP (Q_{E}/Q_{G1}), which is the ratio of cooling capacity to the amount of heat generated, is uniform.

### Example 4: Comparison in Performance Based on Cooling Water Inlet Temperature

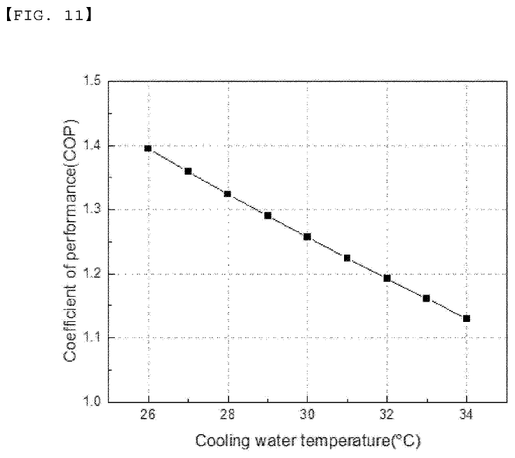

Depending on the season and local climate, the cooling water inlet temperature may vary, and referring to FIG. 11, as the cooling water inlet temperature increases, the temperatures of the absorber and the condenser increase, whereby cooling efficiency is lowered, and therefore the cooling capacity and the COP are reduced.

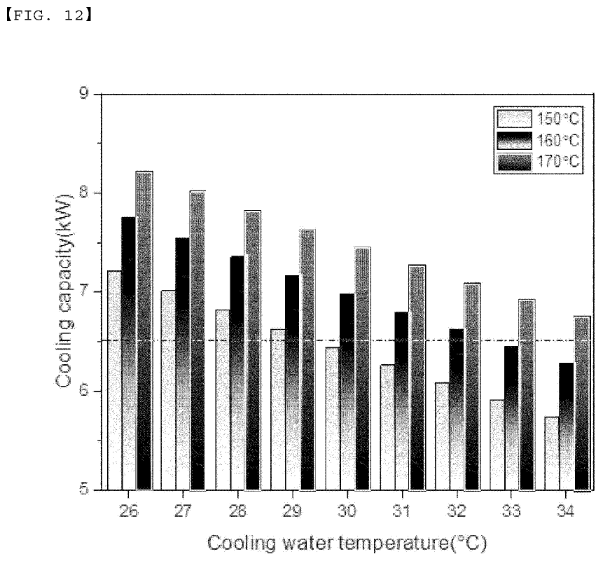

Referring to FIG. 12, on the assumption that the data center has a constant year-round load and generates a cooling load of 7 kW or more, the fuel cell may be operated at 150° C. when the cooling water inlet temperature is 26 to 29° C. In addition, when the cooling water inlet temperature is 29 to 32° C., the fuel cell may be operated at 160° C. Furthermore, when the cooling water inlet temperature is 32 to 34° C., the fuel cell may be operated at 170° C.

Meanwhile, referring to FIG. 12, it can be seen that the operating temperature of the fuel cell must be adjusted within a range of 150° C. to 170° C. in order to secure a cooling capacity of 6 kW or more.

### Example 5: Analysis of Impact of Chilled Water Outlet Temperature on COP and Cooling Capacity

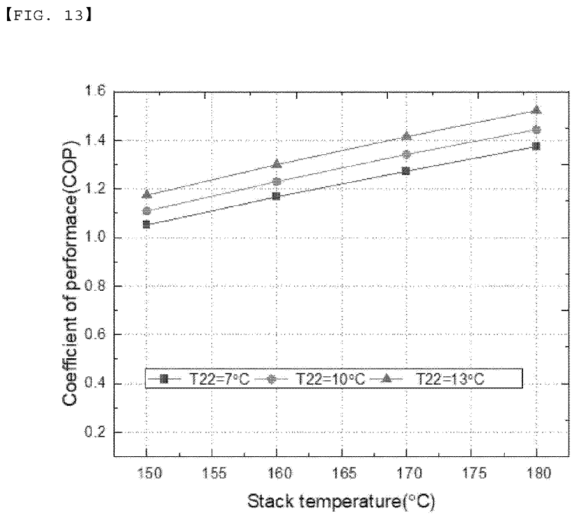

Referring to FIG. 13, increasing the chilled water outlet temperature increases the COP and the cooling capacity. In most cases, typical refrigerator control is performed to uniformly control the outlet temperature of the chilled water, and as the cooling load of the system decreases in the control method, the chilled water outlet temperature decreases accordingly.

Therefore, depending on the temperature and humidity conditions of the data center, the cooling capacity based on the chilled water outlet temperature may be calculated and the operation mode of the fuel cell stack may be selected.

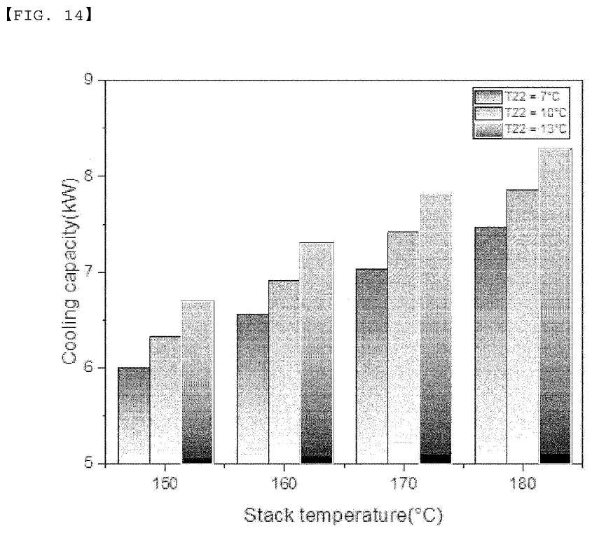

Referring to FIG. 14, for the same cooling capacity, operation must be performed at a stack temperature of 180° C. when the chilled water outlet temperature is 7° C., but operation may be performed at 160° C. when the chilled water outlet temperature is 13° C. Meanwhile, when operation is performed at a chilled water outlet temperature of 7° C. or less in order to secure a cooling capacity of 6 kW or more, it is possible to adjust the stack operating temperature to 160° C. or higher.

The features, structures, effects, etc. described in the above embodiments are included in at least one embodiment of the present invention and are not necessarily limited to one embodiment. Furthermore, the features, structures, effects, etc. exemplified in each embodiment may be combined or modified in other embodiments by a person having ordinary skill in the art to which the embodiments pertain. Accordingly, such combinations and modifications are to be construed as being within the scope of the present invention.

In addition, although the above description has been given based on the embodiments, the embodiments are merely illustrative and do not limit the present invention, and a person having ordinary skill in the art to which the present invention pertains will recognize that many modifications and applications not illustrated above are possible without departing from the essential features of the embodiments. For example, each of the components specifically shown in the embodiments may be modified and implemented. In addition, differences with respect to such modifications and applications should be construed as being within the scope of the present invention as defined by the appended claims.

### INDUSTRIAL APPLICABILITY

A method of controlling the operation of a fuel cell triple cogeneration system according to the present invention is capable of providing an operation scenario strategy of a fuel cell that can satisfy the energy demand conditions of a data center.

1. A method of controlling an operation of a fuel cell triple cogeneration system configured to supply power and cooling heat to a data center, the method comprising:
detecting change in a power load or a cooling heat load of the data center; and
adjusting electrical energy and cooling capacity of the fuel cell triple cogeneration system.

2. The method according to claim 1, further comprising calculating at least one of cooling capacity, electrical efficiency, cooling efficiency, and a coefficient of performance (COP) from a model of the fuel cell triple cogeneration system.

3. The method according to claim 1, further comprising determining current density or operating temperature of a fuel cell from a model of the fuel cell triple cogeneration system.

4. The method according to claim 1, wherein
the fuel cell triple cogeneration system comprises a fuel cell stack and a dual-efficiency absorption refrigerator, and
the dual-efficiency absorption refrigerator comprises:
a first generator configured to separate a cooling fluid into gas and liquid phases;
a second generator configured to separate the cooling fluid introduced from the first generator into gas and liquid phases;
a condenser configured to convert a refrigerant supplied from each of the first generator and the second generator into a liquid phase;
an evaporator configured to cool hot water through evaporation of the refrigerant introduced from the condenser and to produce chilled water;
an absorber configured to absorb steam of the refrigerant introduced from the evaporator again; and
a cooling tower configured to provide cooling water necessary to cool the absorber and the condenser.

5. The method according to claim 4, further comprising calculating cooling capacity and a COP based on outlet temperature of the chilled water produced by the evaporator and determining current density or operating temperature of a fuel cell.

6. The method according to claim 2, wherein the model of the fuel cell triple cogeneration system comprises a fuel cell stack model, a fuel cell system model, and a dual-efficiency absorption refrigerator model.

7. A method of controlling an operation of a fuel cell triple cogeneration system configured to supply power and cooling heat to a data center, the method comprising:
detecting change in cooling water inlet temperature of a dual-efficiency absorption refrigerator; and
adjusting electrical energy and cooling capacity of the fuel cell triple cogeneration system.

8. The method according to claim 7, further comprising calculating at least one of cooling capacity, electrical efficiency, cooling efficiency, and a coefficient of performance (COP) from a model of the fuel cell triple cogeneration system.

9. The method according to claim 7, further comprising determining current density or operating temperature of a fuel cell from a model of the fuel cell triple cogeneration system.

10. The method according to claim 7, wherein
the fuel cell triple cogeneration system comprises a fuel cell stack and a dual-efficiency absorption refrigerator, and
the dual-efficiency absorption refrigerator comprises:
a first generator configured to separate a cooling fluid into gas and liquid phases;
a second generator configured to separate the cooling fluid introduced from the first generator into gas and liquid phases;
a condenser configured to convert a refrigerant supplied from each of the first generator and the second generator into a liquid phase;
an evaporator configured to cool hot water through evaporation of the refrigerant introduced from the condenser and to produce chilled water;
an absorber configured to absorb steam of the refrigerant introduced from the evaporator again; and
a cooling tower configured to provide cooling water necessary to cool the absorber and the condenser.

11. The method according to claim 10, wherein the cooling water inlet temperature is an inlet temperature of the cooling water provided from the cooling tower to the absorber.

12. The method according to claim 8, wherein the model of the fuel cell triple cogeneration system comprises a fuel cell stack model, a fuel cell system model, and a dual-efficiency absorption refrigerator model.
